(19) United States
(12) Patent Application Publication
(10) Pub. No.: US 2025/0318459 A1
(43) Pub. Date: Oct. 16, 2025

(54) ROUTE PLANNING METHOD AND DEVICE, MOWING ROBOT, AND STORAGE MEDIUM

(71) Applicant: SHENZHEN MAMMOTION INNOVATION CO., LIMITED, Shenzhen (CN)

(72) Inventors: Ning WANG, Shenzhen (CN); Zhenhao HUANG, Shenzhen (CN); Weifu ZHANG, Shenzhen (CN)

(73) Assignee: SHENZHEN MAMMOTION INNOVATION CO., LIMITED, Shenzhen (CN)

(21) Appl. No.: 19/033,166

(22) Filed: Jan. 21, 2025

Related U.S. Application Data
(63) Continuation of application No. PCT/CN2023/105175, filed on Jun. 30, 2023.

(30) Foreign Application Priority Data
Jul. 22, 2022 (CN) 202210869217.0

(51) Int. Cl. A01D 34/00; A01D 101/00; G05D 1/246; G05D 1/622; G05D 1/648; G05D 107/20; G05D 109/10

(52) U.S. Cl. CPC A01D 34/008; G05D 1/246; G05D 1/622; G05D 1/6482; G05D 1/6484; A01D 2101/00; G05D 2107/23; G05D 2109/10

(57) ABSTRACT

A route planning method, route planning device and mowing robot are provided to address the issue of mowing robots slipping on slopes, improve mowing performance on slopes, and enhances the mowing efficiency in such terrains. In the method, gradient data and height data corresponding to a mowing area are obtained. A contour map is drawn based on the gradient data and the height data. A mowing trigger request is received, and in response, a mowing route corresponding to the mowing robot is generated based on the contour map and position information of the mowing robot. The mowing robot is then controlled to perform mowing operations based on the mowing route.

### CROSS-REFERENCE TO RELATED APPLICATION

The present application is a continuation application of the International Application No. PCT/CN2023/105175, filed on Jun. 30, 2023, which claims priority to Chinese Patent Application No. 202210869217.0, filed with the China National Intellectual Property Administration on Jul. 22, 2022, and entitled “ROUTE PLANNING METHOD AND DEVICE, MOWING ROBOT, AND STORAGE MEDIUM”, which is incorporated herein by reference in its entirety.

### TECHNICAL FIELD

The present application relates to the field of electronic technologies, and in particular, to a route planning method and device, mowing robot, storage medium.

### BACKGROUND

Mowing robots are widely used for the maintenance of home yards and the mowing of large grasslands. These robots integrate technologies such as motion control, multi-sensor fusion, and path planning. To enable mowing robots to perform mowing tasks, it is necessary to plan their mowing routes, ensuring that all operation areas are fully covered.

However, in existing mowing path planning schemes for mowing robots don't consider uphill or downhill mowing scenarios, resulting in the mowing robot slipping on slopes during mowing. This is especially true in non-forward uphill mowing scenarios, where the slippage becomes more severe. Consequently, the mowing efficiency of the robot is significantly reduced.

### SUMMARY

Embodiments of the present disclosure provide a route planning method and device, mowing robot, and storage medium, which address the issue of mowing robots slipping on slopes, improves the mowing performance on slopes, and enhances the efficiency of mowing in such terrains.

In a first aspect, embodiments of the present disclosure provide a route planning method, comprising:
obtaining gradient data and height data corresponding to a mowing area;
generating a contour map corresponding to the mowing area based on the gradient data and the height data;
generating, in response to a mowing trigger request to the mowing robot, a mowing route corresponding to the mowing robot based on the contour map and position information of the mowing robot, and controlling the mowing robot to perform mowing operations based on the mowing route.

Alternatively, in some embodiments, drawing the contour map corresponding to the mowing area based on the gradient data and the height data comprises:
determining a gradient and a slope direction corresponding to all mowing points in the mowing area based on the gradient data and the height data of the mowing area;
drawing the contour map corresponding to the mowing area based on the height data of the mowing area and the gradient and the slope direction corresponding to all mowing points.

Alternatively, in some embodiments, generating the mowing route corresponding to the mowing robot based on the contour map and the position information of the mowing robot, comprises:
obtaining the height data and the gradient data from the contour map;
dividing the mowing area into a flat area and a sloped area based on the height data and the gradient data;
generating a first mowing route for the flat area and a second mowing route for the sloped area based on the position information of the mowing robot.

Alternatively, in some embodiments, the generating a first mowing route for the flat area and a second mowing route for the sloped area comprises:
generating the first mowing route based on the flat area, a mowing mode of the mowing robot, and the current mowing direction;
generating the second mowing route starting from the endpoint of the first mowing route, based on the sloped area, the mowing mode of the mowing robot, and the current mowing direction.

Alternatively, in some embodiments, after the controlling the mowing robot to perform mowing operations based on the mowing route, the method further comprises:
detecting an altitude of the mowing robot in real-time when the mowing robot performs the mowing operations;
determining whether a current mowing area is a forward-direction upward slope based on the altitude of the mowing robot;
recording all non-forward upward slope areas in the mowing area.

Alternatively, in some embodiments, after controlling the mowing robot to perform the mowing operations based on the mowing route, the method further comprises:
obtaining a gradient of the sloped area and a height of the sloped area;
adjusting the second mowing route based on the non-forward upward slope areas, the gradient data of the sloped area and the height data of sloped area, and generating a third mowing route.

Alternatively, in some embodiments, after controlling the mowing robot to perform the mowing operations based on the mowing route, the method further comprises:
obtaining the collision information of the mowing robot in real time when the mowing robot performs the mowing operations in the sloped area,
adjusting the second mowing route based on the collision information of the mowing robot, the gradient data of the sloped area and the height data of sloped area, and generating a fourth mowing route.

The second aspect of the present disclosure provides a route planning device, including:
an obtaining component, configured to obtain gradient data and height data corresponding to the mowing area;
a drawing component configured to draw a contour map corresponding to the mowing area based on the gradient data and the height data;
a mowing component configured to generate, in response to a mowing trigger request to the mowing robot, a mowing route corresponding to the mowing robot based on the contour map, position information of the mowing robot, and control the mowing robot to perform mowing operations based on the mowing route.

The third aspect of the present disclosure provides a lawn mower robot, comprising a memory, a processor, and a computer program stored in the memory that can be executed on the processor, wherein the processor, when executing the program, implements the steps of the route planning method as described above.

The fourth aspect of the present disclosure provides a non-transitory computer-readable storage medium, on which a computer program is stored, wherein the computer program, when executed by a processor, implements the steps of the route planning method as described above.

In embodiments of the present disclosure, the method comprises obtaining the gradient data and height data corresponding to a mowing area. Drawing a contour map corresponding to the mowing area based on the gradient data and the height data. Generating, in response to a mowing trigger request to the mowing robot, a mowing route corresponding to the mowing robot based on the contour map and position information of the mowing robot. Finally, controlling the mowing robot to perform mowing operations based on the mowing route. In the route planning scheme provided by this disclosure, by drawing a contour map corresponding to the mowing area based on the gradient data and the height data, the gradient and the slope direction at each point of the mowing area are described in the form of the contour map. This is conducive to planning the mowing route on sloped terrain. Additionally, by planning the corresponding mowing route for the sloped terrain, and subsequently controlling the lawnmower to perform the mowing operations along this route, the occurrence of sliding during mowing on slopes can be reduced. This improves the mowing effect on sloped terrain and enhances mowing efficiency.

### BRIEF DESCRIPTION OF THE DRAWINGS

To describe the technical solutions in embodiments of the present application or in the prior art more clearly, the following briefly describes the accompanying drawings required for describing the embodiments or the prior art. It is clear that the accompanying drawings in the following descriptions are merely some embodiments of the present application, and those of ordinary skill in the art may still derive other drawings from these accompanying drawings without creative efforts.

FIG. 1 is a schematic diagram of the scenario for the route planning method provided in the embodiments of this disclosure.

FIG. 2 is a flowchart illustrating the first implementation of the route planning method provided in the embodiments of this disclosure.

FIG. 3 is a schematic diagram of the contour map provided in the embodiments of this disclosure.

FIG. 4 is a flowchart illustrating the second implementation of the route planning method provided in the embodiments of this disclosure.

FIG. 5 is a schematic structural diagram of the route planning device provided in the embodiments of this disclosure.

FIG. 6 is a schematic structural diagram of the lawn mower robot provided in the embodiments of this disclosure.

### DETAILED DESCRIPTION OF EMBODIMENTS

The technical solutions in embodiments of the present application will be described clearly and completely in the following, in conjunction with the accompanying drawings. It should be noted that the described embodiments represent only a portion of the embodiments of this application, not all possible embodiments. Based on the embodiments in this disclosure, all other embodiments obtained by a person skilled in the art without making creative labor fall within the scope of protection of this application.

It should be noted that when a component is recited to be “fixed to” or “disposed on” another component, it may be directly on the other component or indirectly on the other component. When a component is recited to be “connected to” another component, it may be connected directly to the other component or indirectly to the other component. In addition, the connection may be used for either a fixing or a circuit connecting function.

It is to be understood that the terms “length”, “width”, “top”, “bottom”, “front”, ‘rear’, ‘left’, ‘right’, “vertical”, “horizontal”, “top”, “bottom”, “inside”, “outside” and the like indicate orientations or positional relationships based on those shown in the accompanying drawings, and are only intended to facilitate the description of the embodiments of the present invention and to simplify the description, These terms are provided solely for ease of understanding and simplification of the description of the embodiments and should not be interpreted as requiring specific orientations, configurations, or operations of the mentioned devices or components. Thus, these terms should not be construed as limiting the invention.

Furthermore, terms such as “first” and “second” are used merely for descriptive purposes and should not be interpreted as indicating relative importance or implying a particular number of referenced technical features. Accordingly, features designated as “first” or “second” may include one or more of such features, whether explicitly or implicitly. In the description of the embodiments in this application, the term “multiple” means two or more, unless explicitly specified otherwise.

The present disclosure provides a route planning method, device, mowing robot, and storage medium.

The route planning device can be integrated into the microcontroller unit (MCU) of the mowing robot or embedded in a smart terminal or server. The MCU, also known as a single-chip microcomputer or microcontroller, reduces the frequency and specifications of the central processing unit (CPU) while integrating memory, timers, universal serial bus (USB) interfaces, analog-to-digital/digital-to-analog converters, universal asynchronous receiver-transmitter (UART), programmable logic controller (PLC), direct memory access (DMA), and other peripheral interfaces to form a chip-level computer. It is designed for various applications with different control combinations. The mowing robot can automatically move, avoid collisions, return to its charging station within range, perform safety detection and battery level monitoring, and climb slopes to a certain degree. It is especially suitable for lawn maintenance in home gardens, public green spaces, and similar environments. Its features include automatic mowing, grass clipping collection, rain avoidance, automatic charging, obstacle avoidance, compact design, electronic virtual fencing, and network control.

The terminal can be a smartphone, tablet, laptop, desktop computer, smart speaker, smartwatch, or similar device. Terminals and servers can be directly or indirectly connected via wired or wireless communication. The server can be an independent physical server, a cluster of multiple physical servers, or a distributed system. It may also provide foundational cloud computing services such as cloud services, cloud databases, cloud computing, cloud functions, cloud storage, network services, cloud communication, middleware services, domain name services, security services, content delivery networks (CDN), and big data and artificial intelligence platforms. This application does not place any restrictions on these configurations.

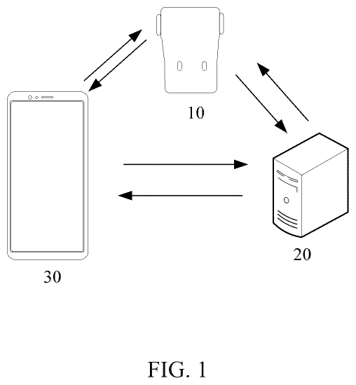

For example, referring to FIG. 1, this disclosure provides a mowing system that includes a mowing robot 10, a server 20, and a user device 30, which are communicatively connected. The user can control the mowing robot 10 to move in advance via user device 30, set a mowing area based on the movement trajectory, and synchronize the corresponding data of the mowing area to the mowing robot 10 and the server 20, Additionally, the mowing robot 10 records historical mowing data corresponding to past mowing operations. Alternatively, in some embodiments, to reduce the storage burden on the mowing robot 10, after completing each mowing operation, the mowing robot 10 can upload the historical mowing data to the server 20. During performance of a mowing operation, the server 20 can send the historical mowing data back to the mowing robot 10. The mowing robot 10 can then generate the corresponding mowing route and delete the local historical mowing data.

For instance, firstly, the gradient data and height data corresponding to a mowing area are obtained, and then a contour map corresponding to the mowing area is drawn based on the gradient data and the height data. The mowing robot 10 responds to a mowing trigger, obtains position information of the mowing robot 10 corresponding to the mowing trigger request, and then, generates a mowing route corresponding to the mowing area based on the contour map and the position information of the mowing robot 10. The mowing area can be predefined by the user through the user device 30, and the mowing robot 10 can locally access this information. Finally, the mowing robot 10 performs the mowing operation based on the mowing route, i.e., the mowing robot 10 performs the mowing operations in the mowing area in accordance with the mowing route.

The route planning scheme provided by the present disclosure includes drawing the contour map of the mowing area based on the gradient data and the height data of the mowing area, and describing the gradient and the slope direction at each point of the mowing area in the form of the contour map, which is conductive to the planning of a mowing route on a sloped terrain. Furthermore, by planning a corresponding mowing path for the sloping terrain, and subsequently controlling the mowing robot to perform mowing operations on the sloping terrain by the mowing path, the mowing robot 10 can reduce the occurrence of sliding when the robot mows the grass on the sloping terrain, to improve the effect of mowing the grass on the sloping terrain and improve the efficiency of mowing the grass on the sloping terrain.

The order of description of the embodiments in this application does not serve as a limitation on the priority of the embodiments.

Embodiments of this application provide a route planning method, comprising: obtaining gradient data and height data corresponding to a mowing area; drawing a contour map corresponding to the mowing area based on the gradient data and the height data; generating, in response to a mowing trigger request to the mowing robot, a mowing route corresponding to the mowing robot based on the contour map and position information of the mowing robot, and controlling the mowing robot to perform mowing operations based on the mowing route.

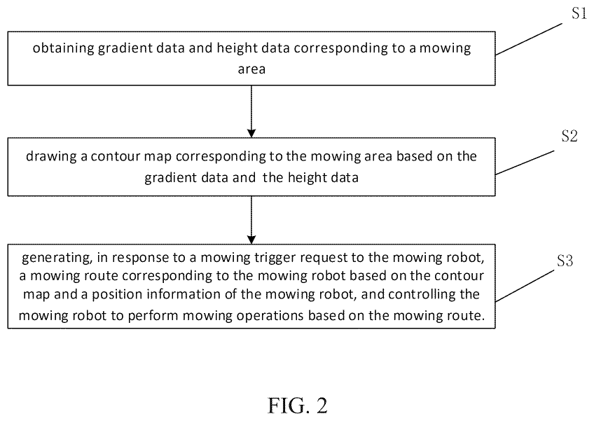

FIG. 2 shows a flow diagram of a route planning method provided by embodiments of the present disclosure. The steps of the route planning method may be as follows:

S1: obtaining gradient data and height data corresponding to a mowing area.

For step S1, the mowing area is first predefined to be calibrated, wherein the mowing area can be predefined by the user through a user device; after obtaining the mowing area for current mowing operation, the mowing robot needs to be controlled to perform a full-coverage automatic mowing of the mowing area, and during this automatic mowing process, the mowing robot records, in real-time, the gradient and the height data of all mowing points of the mowing area.

In embodiments, the mowing area can be a region defined by the user in advance on a mowing map, or it can be determined based on the differential positioning data of the mowing robot and satellite positioning data. The method can be adapted according to the actual situation. The number of mowing areas can be one or more, and the shape and size of the mowing area can be pre-configured by the user. For example, the mowing map corresponding to the mowing robot can be determined based on satellite positioning data. Then, in response to a region division operation for the mowing map, the mowing area can be divided within the mowing map.

S2: drawing a contour map corresponding to the mowing area based on the gradient data and the height data.

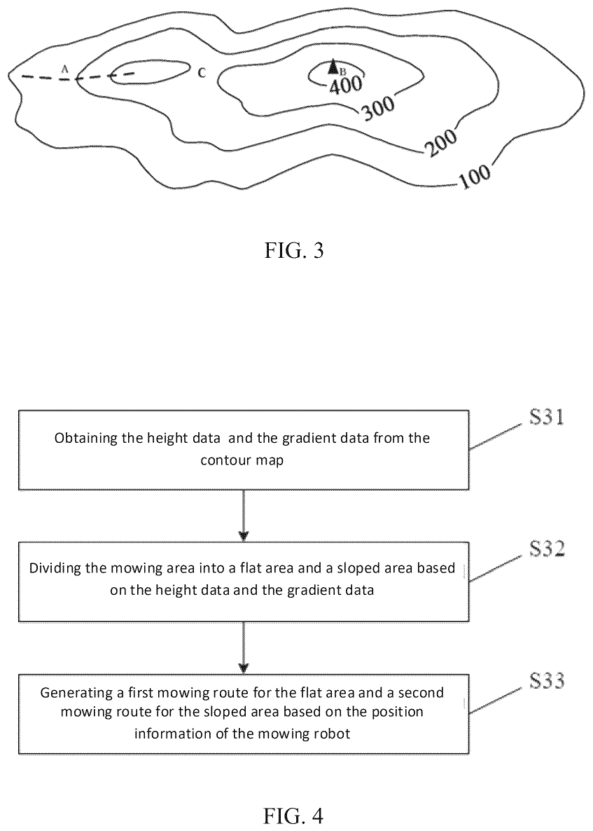

For step S2, based on the gradient data and the height data recorded by the mowing robot during the first full-coverage automatic mowing of the mowing area, a contour map corresponding to the mowing area is generated, as shown in FIG. 3, i.e., the contour map describing the gradient and the slope direction at each mowing point in the form of contour lines.

Alternatively, in some embodiments, step S2 may comprise:

S21: determining a gradient and a slope direction corresponding to all mowing points in the mowing area based on the gradient data and the height data of the mowing area.

S22: drawing the contour map corresponding to the mowing area based on the height data of the mowing area and the gradient and the slope direction corresponding to all mowing points.

Based on the gradient data and the height data of the mowing area, the gradient and the slope direction of all the mowing points in the mowing area are determined, and all the mowing points are categorized into two types, namely, flat area and sloped area; then, a contour map corresponding to the mowing area is generated based on the height data, the gradient, and the slope direction of all the points in the mowing area. The contour map divides all the mowing points in the area into different height grades based on a preset height gradient difference and a predetermined height grade. Finally, mowing points at the same height grade are connected to form a curve. In some embodiments, mowing points can be set at predetermined intervals within the mowing area, or they can be range covered by the mowing robot performing mowing operations in the mowing area at preset time intervals.

S3: generating, in response to a mowing trigger request to the mowing robot, a mowing route corresponding to the mowing robot based on the contour map and position information of the mowing robot, and controlling the mowing robot to perform mowing operations based on the mowing route.

For step S3, the mowing trigger request can be triggered by the mower robot itself, by the server, or by the user through hardware or software. For example, if the mower robot needs to perform a scheduled mowing operation, the mowing trigger request can be triggered at the set time. Alternatively, the server can send the mowing trigger request based on the reported mowing trigger instruction. Additionally, the user can input the mowing operations through an application on their mobile phone, and the cell phone generates a mowing trigger request for the mowing robot based on the mowing operations.

In some embodiments, the mowing trigger request carries historical mowing information of the mowing robot, the historical mowing information including details such as historical mowing data, historical mowing direction, historical mowing area, and the corresponding contour map. Upon receiving the mowing trigger request for the mower robot, the target mowing area and its contour map can be extracted from the mowing trigger request. Then, based on the contour map and the mower robot's position information, the mowing route for the mower robot can be generated. Finally, based on the generated mowing route, the mower robot can be navigated to the target mowing area to perform the mowing operation.

In some embodiments, the generating the mowing route corresponding to the mowing robot based on the contour map and the position information of the mowing robot in step S3 can comprises:

S31: Obtaining the height data and the gradient data from the contour map.

S32: dividing the mowing area into a flat area and a sloped area based on the height data and the gradient data.

S33: generating a first mowing route for the flat area and a second mowing route for the sloped area based on the position information of the mowing robot.

The steps for generating the mowing path in step S3 are as follows: obtaining the contour map that has been previously drawn, obtaining the height data and the gradient data of all mowing points of the mowing area from the contour map; and then, dividing the mowing area into a flat area and a sloped area based on the height data and the gradient data of all mowing points of the mowing area. Mowing points in the mowing area with height data equal to 0 may be categorized as flat areas, while mowing points with non-zero height data may be categorized as part of the sloped area. Alternatively, mowing points with the same height as their two adjacent points can be categorized as part of the flat area, while mowing points with different height compared to adjacent points can be classified as part of the sloped area. After dividing the mowing area into flat area and sloped area, a first mowing path for the flat area and a second mowing route for the sloped area are generated, respectively, by combining the position information of the mowing robot.

Alternatively, as shown in FIG. 4, the step S33 can comprise the following:

S331: generating the first mowing route based on the flat area, the mowing robot's mowing mode, and the current mowing direction.

S332: generating the second mowing route, starting from the endpoint of the first mowing route, based on the sloped area, the mowing robot's mowing mode, and the current mowing direction.

The steps for generating the first mowing path for the flat area and the second mowing path for the sloped area are as follows:

Obtaining the position information of all mowing points in the flat area, and considering the mower robot's mowing mode and current mowing direction to plan the first mowing route for the flat area. Additionally, the mowing robot's current position can be considered as a starting point to plan a route that covers all the mowing points in the flat area. The mowing robot's mowing mode, which could include a rectangular bow-shaped mode, spiral mode, back-and-forth mode, and the like, is not limited herein.

Obtaining the position information of all mowing points in the sloped area and planning the second mowing route for the sloped area by considering the mowing robot's mowing mode, current mowing direction, and current position. A starting point of the second mowing route is the endpoint of the first mowing route, so that a seamless transition between the flat area and the sloped area can be realized. Additionally, the second mowing route corresponding to the sloped area can be a route comprised of at least one segment. A separate segment of the mowing route may be generated for an area in which the sloped area is concentrated to improve the efficiency and effectiveness of the mowing.

In embodiments, to fully utilize the climbing ability of the four-wheel-drive mowing robot and prevent slippage on slopes, the upward slope method for the second mowing path primarily follows the principle of forward-direction upward slope.

Alternatively, in some embodiments, after controlling the mowing robot to perform mowing operations based on the mowing route in step S3, the method may further comprise:
(11) detecting an altitude of the mowing robot in real-time when the mowing robot performs the mowing operations;
(12) determining whether a current mowing area is a forward-direction upward slope based on the altitude of the mowing robot;
(13) recording all non-forward upward slope areas in the mowing area.

When controlling the mowing robot to perform mowing operations based on the mowing path, the method further includes recording non-forward upward slope areas within the mowing area. For example, during the mowing operations, the mowing robot's altitude is detected in real-time. The altitude detection method includes, but is not limited to, detecting the mowing robot's altitude via an inertial detection unit. Based on the altitude information of the mowing robot, determining the mowing point at that moment is on an upward slope in the forward direction, or determining, based on the altitude information of the mowing robot during a period of working time, whether the mowing area is the forward-direction upward slope; and recording, in real time, all non-forward upward slope areas or non-forward upward slope mowing points in the mowing area. In embodiments of this application, forward-direction upward slope is defined as when the acceleration direction of the mowing robot during the upward slope movement meets a first preset angle range. In this case, the area where the mowing robot is located is considered a forward-direction upward slope area, or the mowing route of the mowing robot at that moment is considered a forward-direction upward slope route. If the acceleration of the mowing robot during the upward slope movement does not meet the first preset angle range, it is judged that the mowing robot is in a non-forward upward slope state, and the area where it is located is considered a non-forward upward slope area.

Alternatively, in some embodiments, after controlling the mowing robot to perform mowing operations based on the mowing route in step S3, the process may further include:
(21) Obtaining the gradient data and height data of the sloped area;
(22) Adjusting the second mowing route based on the non-forward upward slope areas, the gradient data of the sloped area, and the height data of sloped area, and generating a third mowing route.

In embodiments of a non-forward upward slope scenario, due to the effect of gravity causing the mowing robot to slide during movement, after controlling the mowing robot to perform mowing operations based on the mowing route, the second mowing path is further adjusted. The process can be as follows: obtaining the gradient data and the height data of the sloped area in the mowing area, and combining the recorded results of non-forward upward slope area and readjusting the second mowing route for the sloped area, primarily focusing on forward-direction upward slope route, and avoiding focusing on non-forward upward slope. After adjustment, a third mowing route is generated.

Alternatively, in some embodiments, after controlling the mowing robot to perform mowing operations based on the mowing route in step S3, the process may further include:
(31) obtaining the collision information of the mowing robot in real time when the mowing robot performs the mowing task in the sloped area,
(32) adjusting the second mowing route based on the collision information of the mowing robot and the gradient data of the sloped area and the height data of sloped area, and generating a fourth mowing route.

After controlling the mowing robot to perform mowing operations based on the mowing route, it further includes adjusting the mowing route based on recorded collision information from the mowing area. This includes: detecting in real time the collision information of an obstacle that collides with an obstacle when the mowing robot performs the mowing operation in the sloping region, invoking the replanning logic, and adjusting the second mowing route for the second mowing route for the sloped area, and generating a fourth mowing route; the first mowing route for the flat area may also be adjusted based on the collision information and the height data and the gradient data of the flat area to generate a fifth mowing path.

In the embodiment of the present disclosure, the method first obtaining the gradient data and height data corresponding to a mowing area; Then, drawing a contour map corresponding to the mowing area based on the gradient data and the height data; Next, generating, in response to a mowing trigger request to the mowing robot, a mowing route corresponding to the mowing robot based on the contour map and position information of the mowing robot; Finally, controlling the mowing robot to perform mowing operations based on the mowing route. In the route planning scheme provided by this disclosure, by drawing a contour map corresponding to the mowing area based on the gradient data and the height data, the gradient and the slope direction at each point of the mowing area are described in the form of the contour map, which is conducive to planning the mowing route on sloped terrain. Additionally, by planning the corresponding mowing route for the sloped terrain, and subsequently controlling the lawnmower to perform the mowing operations along this route, the occurrence of sliding during mowing on slopes can be reduced. Furthermore, the mowing route is adjusted in real time to further reduce the risk of slippage, therefore it can be seen that the embodiment of the present disclosure can improve the mowing effect on the slopes and improve the efficiency of mowing on the slopes.

To facilitate the better implementation of the path planning method in embodiments of the present application, a path planning device is provided based on the above method. The meanings of the terms are the same as those in the path planning method described above, and implementation details can be found in the method embodiment's description.

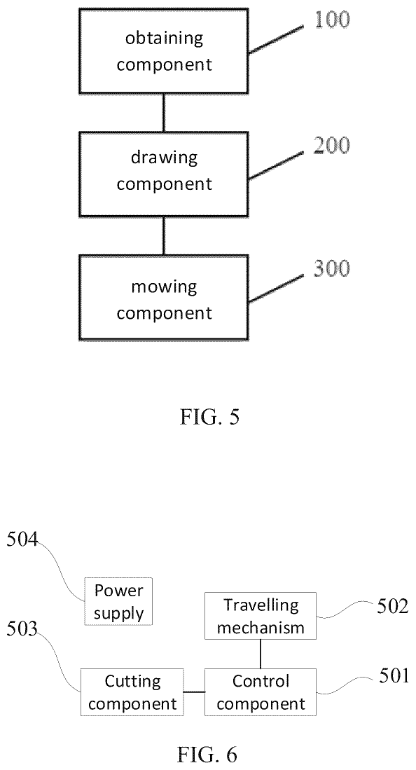

FIG. 5 is a schematic diagram of the structure of the route planning device provided in embodiments of the present disclosure. The path planning device can include an obtaining component 100, a drawing component 200, and a mowing component 300. Components, modules and units in this application can be implemented by hardware, software or a combination of hardware and software. Components, modules and units in this application can be circuits, for example, the obtaining component can be an obtaining circuit. Components, modules and units can be implemented by a processor (e.g., CPU) executing instructions stored in a memory.

An obtaining component 100 is configured to obtain gradient data and height data corresponding to the mowing area.

In embodiments of this application, for the obtaining component 100, the mowing area is first predefined to be calibrated, wherein the mowing area can be predefined by the user through a user device. After obtaining the mowing area for current mowing operation, the mowing robot needs to be controlled to perform a full-coverage automatic mowing of the mowing area. During this automatic mowing process, the mowing robot records, in real-time, the gradient and the height data of all mowing points of the mowing area.

A drawing component 200 is configured to draw a contour map corresponding to the mowing area based on the gradient data and the height data.

For the drawing component 200, based on the gradient data and the height data recorded by the mowing robot during the first full-coverage automatic mowing of the mowing area, a contour map corresponding to the mowing area is drawn, as shown in FIG. 3, i.e., the contour map describing the gradient and the slope direction at each mowing point in the form of contour lines is drawn.

Alternatively, in some embodiments, the drawing component 200 may comprise:
A first drawing unit, configured to determine a gradient and a slope direction corresponding to all mowing points in the mowing area based on the gradient data and the height data of the mowing area;
A second drawing unit, configured to draw the contour map corresponding to the mowing area based on the height data of the mowing area and the gradient and the slope direction corresponding to all mowing points.

A mowing component 300 is configured to generate, in response to a mowing trigger request to the mowing robot, a mowing route corresponding to the mowing robot based on the contour map and position information of the mowing robot, and control the mowing robot to perform mowing operations based on the mowing route.

The mowing trigger request can be triggered by the mower robot itself, by the server, or by the user through hardware or software. For example, if the mower robot needs to perform a scheduled mowing operation, the mowing trigger request can be triggered at the set time. Alternatively, the server can send the mowing trigger request based on the reported mowing trigger instruction. Additionally, the user can input the mowing operations through an application on their mobile phone, and the mobile phone generates a mowing trigger request for the mowing robot based on the mowing operations.

Alternatively, in some embodiments, the mowing unit 300 can comprise:

A first obtaining unit configured to obtain the height data and the gradient data from the contour map.

A region division unit configured to divide the mowing area into a flat area and a sloped area based on the height data and the gradient data.

A route generation unit configured to generate a first mowing route for the flat area and a second mowing route for the sloped area based on the position information of the mowing robot.

Alternatively, in some embodiment, a route generation unit can comprise the following:

A first route generation sub-unit configured to generate the first mowing route based on the flat area, the mowing robot's mowing mode, and the current mowing direction.

A second route generation sub-unit configured to generate the second mowing route to start from the endpoint of the first mowing route, based on the sloped area, the mowing robot's mowing mode, and the current mowing direction.

Alternatively, in some embodiment, the route planning device further comprises:

A route adjustment unit configured to: detect an altitude of the mowing robot in real-time when the mowing robot performs the mowing operations; determine whether a current mowing area is a forward-direction upward slope based on the altitude of the mowing robot; record all non-forward upward slope areas in the mowing area; obtain the gradient data and height data of the sloped area; adjust the second mowing route based on the non-forward upward slope areas, the gradient data of the sloped area, and the height data of sloped area; and generate a third mowing route.

Alternatively, in some embodiments, the route adjustment unit may further configured to: obtain collision information of the mowing robot in real time when the mowing robot performs the mowing task in the sloped area; adjust the second mowing route based on the collision information of the mowing robot, the gradient data of the sloped area, and the height data of sloped area; and generate a fourth mowing route.

In embodiments of the present disclosure, the obtaining component 100 is configured to obtain the gradient data and height data corresponding to a mowing area. The drawing component 200 is configured to draw a contour map corresponding to the mowing area based on the gradient data and the height data. The mowing component 300 is configured to generate, in response to a mowing trigger request to the mowing robot, a mowing route corresponding to the mowing robot based on the contour map and position information of the mowing robot. Finally, the mowing robot is controlled to perform mowing operations based on the mowing route. In the route planning scheme provided by this disclosure, by drawing a contour map corresponding to the mowing area based on the gradient data and the height data, the gradient and the slope direction at each point of the mowing area are described in the form of the contour map, which is conducive to planning the mowing route on sloped terrain. Additionally, by planning the corresponding mowing route for the sloped terrain, and subsequently controlling the lawnmower to perform the mowing operations along this route, the occurrence of sliding during mowing on slopes can be reduced. Furthermore, the mowing route is adjusted in real time to further reduce the risk of slippage. Therefore it can be seen that the embodiment of the present disclosure can improve the mowing effect on the slopes and improve the efficiency of mowing on the slopes.

Additionally, embodiments of the present disclosure also provide a mowing robot, as shown in FIG. 6, which illustrates a schematic diagram of the structure of the mowing robot in embodiments this application. The mowing robot can include components such as a control component 501, a traveling mechanism 502, a cutting component 503, and a power supply 504. One skilled in the art will understand that the structure of the mowing robot shown in FIG. 6 does not constitute a limitation of the mowing robot, as it may include more or fewer components than shown, or some components may be combined, or different component arrangements may be used.

The control component 501 is the control center of the mowing robot. The control component 501 can include a central processing unit (CPU), memory, input/output ports, system bus, timer/counter, digital-to-analog converter (DAC), and analog-to-digital converter (ADC), among other components. The CPU executes various functions of the mowing robot and processes data by running or executing software programs and/or modules stored in memory, as well as calling data stored in memory. Preferably, the CPU can integrate an application processor and a modem processor, where the application processor mainly handles the operating system and applications, while the modem processor primarily handles wireless communication. It can be understood that the modem processor may also not be integrated into the CPU.

Memory can store software programs and modules. The CPU executes the various functions and applications, as well as data processing, by running software programs and modules stored in the memory. The memory can include a program storage area and a data storage area. The program storage area can store the operating system and at least one application required for functions (e.g., sound playback function, image playback function, etc.) The data storage area can store data created based on the use of the mowing robot. Additionally, the memory can include high-speed random access memory (RAM), and it may also include non-volatile memory such as at least one disk storage device, flash memory device, or other volatile solid-state storage devices. Correspondingly, the memory can also include a memory controller to provide the CPU access to the memory.

Traveling Mechanism 502 is electrically connected to the control component 501. It responds to the control signals transmitted from the control component 501 to adjust the mowing robot's speed and direction, enabling its autonomous movement.

Cutting Module 503 is electrically connected to the control component 501. It responds to the control signals transmitted from the control module to adjust the cutting disk's height and speed to perform the mowing operations.

Power Supply 504 can be connected to the control component 501 via a power management system, which manages functions such as charging, discharging, and power consumption. The power supply 504 can include one or more direct current (DC) or alternating current (AC) power sources, a recharging system, a power failure detection circuit, a power converter or inverter, a power status indicator, or any other components.

Although not shown, the mowing robot can also include a communication module, a sensor module, a notification module, etc., which will not be elaborated here.

A Communication Module is used for receiving and transmitting signals during the information exchange process. It establishes a communication connection with user devices, base stations, or servers to enable signal transmission between the user device, base station, or server.

A Sensor Module is used to collect internal or external environmental data and feedback this data to the control module for decision-making. It enables precise positioning and intelligent obstacle avoidance of the mowing robot. Optionally, the sensors may include ultrasonic sensors, infrared sensors, collision sensors, rain sensors, light detection and ranging (LiDAR) sensors, inertial measurement units, wheel encoders, image sensors, position sensors, and other sensors.

Notification Module is used to inform the user of the current operational status of the mowing robot. In some embodiments, the notification module includes, but is not limited to, indicator lights, buzzers, etc. For example, the mowing robot can use indicator lights to show the current power status, motor operation status, sensor operation status, etc. Additionally, when the mowing robot encounters a malfunction or is stolen, the buzzer can sound an alarm.

In some embodiment, the processor in the control module 501 follows instructions to load executable files corresponding to one or more application program processes into the memory, and the processor runs the programs stored in the memory to realize various functions, such as:
Acquiring slope data and height data corresponding to the mowing area;
Drawing the contour map corresponding to the mowing area based on the slope and height data;
In response to the mowing trigger request for the mowing robot, generating the corresponding mowing path based on the contour map and the mowing robot's position information, and controlling the mowing robot to perform mowing operations based on the mowing path.

For detailed implementation of these operations refer to the previous embodiments, which will not be elaborated here again.

This application first obtains the slope and height data corresponding to the mowing area, then draws the contour map corresponding to the mowing area based on the slope and height data. Next, in response to a mowing trigger request, a mowing path corresponding to the mowing robot is generated based on the contour map and a robot's position. Finally, the mowing robot is controlled to perform mowing operations based on the generated mowing path.

In the path planning solution provided by this application, the contour map of the mowing area is drawn based on the slope and height data of the mowing area. The slope and direction at each point on the mowing area are described in the form of contour lines, which helps in planning the mowing path on the slope. Additionally, for the planned mowing path on the slope, the mowing robot follows this path to perform mowing operations on the slope, reducing the risk of sliding during slope mowing and improving the effectiveness and efficiency of mowing on slopes.

One skilled in the art can understand that all or part of the steps in the above methods can be completed via instructions or by controlling related hardware via instructions. These instructions can be stored in a computer-readable storage medium and loaded and executed by a processor.

Therefore, this application also provides a storage medium in which multiple instructions are stored. These instructions can be loaded by a processor to execute the steps of any of the path planning methods provided in this application. For example, these instructions can execute the following steps:
Obtaining gradient data and height data corresponding to the mowing area;
Drawing the contour map corresponding to the mowing area based on the gradient data and the height data;
In response to the mowing trigger request for the mowing robot, generating the corresponding mowing route based on the contour map and the mowing robot's position information, and controlling the mowing robot to perform mowing operations based on the mowing route.

For detailed implementation of these operations refer to the previous embodiments, which will not be described again.

The storage medium can include, but is not limited to, read-only memory (ROM), RAM, magnetic disks or optical disks, etc.

Since the instructions stored in the storage medium can execute the steps of any of the path planning methods provided in this application, the beneficial effects achievable by any of the path planning methods can also be realized. The details of these beneficial effects are explained in the previous embodiments and will not be reiterated here.

The above detailed description of the path planning method, device, mowing robot, and storage medium provided by this application is intended to help understand the principles and implementation methods of this application. The descriptions of the embodiments are for illustrative purposes, only to aid in understanding the method and its core concepts. Furthermore, for those skilled in the art, various changes may be made in the implementation and application scope based on the ideas of this application. Therefore, the content of this specification should not be understood as a limitation of this application.

1. A route planning method, comprising:
obtaining gradient data and height data corresponding to a mowing area;
drawing a contour map corresponding to the mowing area based on the gradient data and the height data;
generating, in response to a mowing trigger request to a mowing robot, a mowing route corresponding to the mowing robot based on the contour map and position information of the mowing robot; and
controlling the mowing robot to perform mowing operations based on the mowing route.

2. The route planning method according to claim 1, wherein the drawing the contour map corresponding to the mowing area based on the gradient data and the height data comprises:
determining a gradient and a slope direction corresponding to a plurality of mowing points in the mowing area based on the gradient data and the height data of the mowing area;
drawing the contour map corresponding to the mowing area based on the height data of the mowing area, and the gradient and the slope direction corresponding to the plurality of mowing points.

3. The route planning method according to claim 1, wherein the generating the mowing route corresponding to the mowing robot based on the contour map and the position information of the mowing robot, comprises:
obtaining the height data and the gradient data from the contour map;
dividing the mowing area into a flat area and a sloped area based on the height data and the gradient data;
generating a first mowing route for the flat area and a second mowing route for the sloped area based on the position information of the mowing robot.

4. The route planning method according to claim 3, wherein the generating the first mowing route for the flat area and the second mowing route for the sloped area comprises:
generating the first mowing route based on the flat area, a mowing mode of the mowing robot, and a current mowing direction;
generating the second mowing route starting from an endpoint of the first mowing route, based on the sloped area, the mowing mode of the mowing robot, and the current mowing direction.

5. The route planning method according to claim 3, wherein after the controlling the mowing robot to perform mowing operations based on the mowing route, the method further comprises:
detecting an altitude of the mowing robot in real-time when the mowing robot performs the mowing operations;
determining whether a current mowing area is a forward-direction upward slope based on the altitude of the mowing robot;
recording a plurality of non-forward upward slope areas in the mowing area.

6. The route planning method according to claim 5, wherein after controlling the mowing robot to perform the mowing operations based on the mowing route, the method further comprises:
obtaining a gradient of the sloped area and a height of the sloped area;
adjusting the second mowing route based on the plurality of non-forward upward slope areas in the mowing area, the gradient data of the sloped area, and the height data of the sloped area; and
generating a third mowing route.

7. The route planning method according to claim 5, wherein after controlling the mowing robot to perform the mowing operations based on the mowing route, the method further comprises:
obtaining, in real time, collision information of the mowing robot when the mowing robot performs the mowing operations in the sloped area,
adjusting the second mowing route based on the collision information of the mowing robot, the gradient data of the sloped area, the height data of the sloped area; and
generating a fourth mowing route.

8. A route planning device, comprising:
a processor executing an obtaining component, a drawing component, and a mowing component stored in a memory, wherein
the obtaining component is configured to obtain gradient data and height data corresponding to a mowing area;
the drawing component is configured to draw a contour map corresponding to the mowing area based on the gradient data and the height data;
the mowing component is configured to generate, in response to a mowing trigger request to a mowing robot, a mowing route corresponding to the mowing robot based on the contour map and position information of the mowing robot, and control the mowing robot to perform mowing operations based on the mowing route.

9. The route planning device according to claim 8, wherein the drawing component comprises:
a first drawing component executed by the processor, configured to determine a gradient and a slope direction corresponding to a plurality of mowing points in the mowing area based on the gradient data and the height data of the mowing area;
a second drawing component executed by the processor, configured to draw the contour map corresponding to the mowing area based on the height data of the mowing area, and the gradient and the slope direction corresponding to the plurality of mowing points.

10. The route planning device according to claim 8, wherein the mowing component comprises:
a first obtaining component executed by the processor, configured to obtain the height data and the gradient data from the contour map;
a region division component executed by the processor, configured to divide the mowing area into a flat area and a sloped area based on the height data and the gradient data;
a route generation component executed by the processor, configured to generate a first mowing route for the flat area and a second mowing route for the sloped area based on the position information of the mowing robot.

11. The route planning device according to claim 10, wherein the route generation component comprises:
a first route generation sub-component executed by the processor, configured to generate the first mowing route based on the flat area, a mowing mode of the mowing robot, and a current mowing direction;
a second route generation sub-component executed by the processor, configured to generate the second mowing route starting from an endpoint of the first mowing route, based on the sloped area, the mowing mode of the mowing robot, and the current mowing direction.

12. The route planning device according to claim 10, wherein the device further comprises:
a route adjustment component executed by the processor, configured to:
detect an altitude of the mowing robot in real-time when the mowing robot performs the mowing operations;
determine whether a current mowing area is a forward-direction upward slope based on the altitude of the mowing robot;
record a plurality of non-forward upward slope areas in the mowing area.

13. The route planning device according to claim 12, wherein the route adjustment component is further configured to:
obtain a gradient of the sloped area and a height of the sloped area;
adjust the second mowing route based on the plurality of non-forward upward slope areas, the gradient data of the sloped area, and the height data of sloped area, and
generate a third mowing route.

14. The route planning method according to claim 12, the route adjustment component is further configured to:
obtain collision information of the mowing robot in real time when the mowing robot performs the mowing operations in the sloped area,
adjust the second mowing route based on the collision information of the mowing robot, the gradient data of the sloped area, the height data of the sloped area, and generate a fourth mowing route.

15. A mowing robot, comprising a memory and a processor executing code in the memory to implement a route planning method comprising:
obtaining gradient data and height data corresponding to a mowing area;
drawing a contour map corresponding to the mowing area based on the gradient data and the height data;
generating, in response to a mowing trigger request to the mowing robot, a mowing route corresponding to the mowing robot based on the contour map and position information of the mowing robot; and
controlling the mowing robot to perform mowing operations based on the mowing route.

16. The mowing robot according to claim 15, wherein the drawing the contour map corresponding to the mowing area based on the gradient data and the height data comprises:
determining a gradient and a slope direction corresponding to a plurality of mowing points in the mowing area based on the gradient data and the height data of the mowing area;
drawing the contour map corresponding to the mowing area based on the height data of the mowing area and the gradient and the slope direction corresponding to the plurality of mowing points.

17. The mowing robot according to claim 15, wherein the generating the mowing route corresponding to the mowing robot based on the contour map and the position information of the mowing robot, comprises:
obtaining the height data and the gradient data from the contour map;
dividing the mowing area into a flat area and a sloped area based on the height data and the gradient data;
generating a first mowing route for the flat area and a second mowing route for the sloped area based on the position information of the mowing robot.

18. The mowing robot according to claim 17, wherein the generating the first mowing route for the flat area and the second mowing route for the sloped area comprises:
generating the first mowing route based on the flat area, a mowing mode of the mowing robot, and a current mowing direction;
generating the second mowing route starting from an endpoint of the first mowing route, based on the sloped area, the mowing mode of the mowing robot, and the current mowing direction.

19. The mowing robot according to claim 15, wherein after the controlling the mowing robot to perform mowing operations based on the mowing route, the method further comprises:
detecting an altitude of the mowing robot in real-time when the mowing robot performs the mowing operations;
determining whether a current mowing area is a forward-direction upward slope based on the altitude of the mowing robot;
recording a plurality non-forward upward slope areas in the mowing area.

20. The mowing robot according to claim 17, wherein after controlling the mowing robot to perform the mowing operations based on the mowing route, the method further comprises:
obtaining a gradient of the sloped area and a height of the sloped area;
adjusting the second mowing route based on the non-forward upward slope areas and the gradient data of the sloped area and the height data of the sloped area; and
generating a third mowing route.
